(19) United States
(12) Patent Application Publication
(10) Pub. No.: US 2026/0127981 A1
(43) Pub. Date: May 7, 2026

(54) VIRTUAL REALITY SYSTEM WITH ATTACHABLE SENSOR SYSTEM

(71) Applicant: xReality Group Ltd, Penrith, NSW (AU)

(72) Inventors: Wayne Jones, Penrith (AU); Landon Curry, Penrith (AU)

(73) Assignee: xReality Group Ltd, Penrith, NSW (AU)

(21) Appl. No.: 19/116,644

(22) PCT Filed: Apr. 12, 2023
(86) PCT No.: PCT/AU2023/050303

§ 371 Date: Mar. 28, 2025

(30) Foreign Application Priority Data
Sep. 30, 2022 (AU) 2022902841

(51) Int. Cl. G09B 19/24; A63F 13/211; A63F 13/212; A63F 13/245; A63F 13/428; A63F 13/52; A63F 13/65; A63F 13/837; A63F 13/98; F41A 33/06; G02B 27/01; G06F 3/01; G09B 9/00; H04W 4/38

(52) U.S. Cl. CPC G09B 19/24; A63F 13/211; A63F 13/212; A63F 13/245; A63F 13/428; A63F 13/52; A63F 13/65; A63F 13/837; A63F 13/98; F41A 33/06; G02B 27/017; G06F 3/012; G09B 9/003; H04W 4/38

(57) ABSTRACT

A virtual reality system (100), including: a piece of equipment (150); a sensor system (101) including a wireless communication interface (114). The sensor system (101) is configured to obtain one or more sensor signals and wirelessly transfer sensor data. The system (100) further includes a virtual reality headset (121) worn by the user (160) associated with the equipment (150), including a processor (124), a memory (126), a display (130), an accelerometer (132), a positional sensor (136), and a wireless communication interface (134) in communication with the sensor system (101). The memory (126) of the virtual reality headset (121) includes executable instructions to configure the virtual reality headset (121) to: present a virtual reality environment to the user (160); receive, from the sensor system (121), the sensor data; and update, based on the sensor data, presentation of the virtual reality environment to display to the user (160).

### RELATED APPLICATIONS

The present application claims priority from Australian provisional application 2022902841, filed 30 Sep. 2022, the contents of which is herein incorporated by reference in entirety.

### TECHNICAL FIELD

The present invention relates to a virtual reality system.

### BACKGROUND

Various personnel are routinely required to carry specialist tools and equipment with the potential to utilise them in spontaneous circumstances. For example, military, police, security guards, and similar tactical operators may be required to carry a firearm with the potential to utilise them in spontaneous use of force actions. These circumstances can result in fatal consequences. In some situations, spontaneous actions are rarely executed and generally only employed in response to an individual's perception of an imminent threat.

When such personnel are placed in unfamiliar circumstances, the chance of a spontaneous action being undertaken is substantially increased. This can lead to one or more fatalities which may have been avoided if the personnel had training in a particular circumstance.

It is advantageous to make a training experience as realistic as possible. This involves the personnel being dressed in the same attire and using a similar equipment that they would normally use. The use of similar equipment has led to difficulties in the field as the feel of the equipment in training can often be different to a personnel's actual equipment. For example, for law enforcement and military personnel, the weight of the weapon and the trigger pressure of the weapon can be vastly different to that of the tactical operator's actual weapon. This could lead to accidental firing or less precise movement of the weapon in the field when compared to training. Similarly, for emergency personnel, an emergency training tool could feel quite different to the real tool in the field.

### SUMMARY

It is an object of the invention to overcome and/or alleviate one or more of the above disadvantages or provide a useful or commercial alternative.

In one aspect there is provided a virtual reality system, including: a piece of equipment; a sensor system attachable to at least one of the user or the piece of equipment, wherein the sensor system includes a positional sensor, a gyroscope, an accelerometer, and a wireless communication interface, wherein the sensor system is configured to obtain, from the positional sensor, the gyroscope and/or the accelerometer, one or more sensor signals and wirelessly transfer sensor data; and a virtual reality headset worn by a user associated with the equipment, including a processor, a memory, a display, an accelerometer, a positional sensor, and a wireless communication interface in communication with the sensor system; wherein the memory of the virtual reality headset includes executable instructions which, when executed by the processor of the virtual reality headset, configure the virtual reality headset to: present a virtual reality environment via the display to the user; receive, from the sensor system via the wireless communication interface of the virtual reality headset, the sensor data; and update, via the display and based on the sensor data, presentation of the virtual reality environment to display to the user.

In certain embodiments, the piece of equipment is a weapon.

In certain embodiments, the sensor system includes a sensor microcontroller including a processor and a memory having stored therein executable instructions which when executed by the processor of the sensor microcontroller, configure the processor of the sensor microcontroller to detect a simulated firing of the weapon based on one or more sensor signals received from the accelerometer.

In certain embodiments, the memory of the sensor microcontroller has stored therein executable instructions defining a machine-trained model for detecting the simulated firing of the weapon based on the one or more sensor signals received from the accelerometer.

In certain embodiments, the virtual reality system further includes a control processing device including a memory, a communication interface and a processor configured to establish a wireless network which allows the virtual reality headset to communicate wirelessly with the control processing system.

In certain embodiments, the wireless network utilises IEEE 802.11 family of wireless network protocols.

In certain embodiments, the communication interface of the sensor system communicates with the virtual reality headset using a different wireless network.

In certain embodiments, the communication interface of the sensor system communicates with the virtual reality headset utilising IEEE 802.15.1 protocol.

In certain embodiments, the control processing system is a tablet computing device.

In certain embodiments, the control processing system has stored in the memory an executable software application which, when executed by the processor of the control processing system, configures the control processing system to present, via a display of the control processing system, a control interface to allow a trainer to select, via an input device of the tablet processing system, a training scenario for the user wearing the virtual reality headset.

In certain embodiments, the control processing system is configured to receive, from the virtual reality headset, virtual reality data indicative of positional and orientation data associated with the virtual reality environment, regenerate the virtual reality environment based on the virtual reality data, and present a view of the regenerated virtual reality environment.

In certain embodiments, the virtual reality data, including the position and orientation data, is temporally dependent to allow the virtual reality environment to be regenerated according to time.

In certain embodiments, the control processing system is configured to store the virtual reality headset data in at least one of: the memory of the control processing system; and memory of a remote processing system.

In certain embodiments, the control processing system is configured to present, via the display of the control processing system, the regenerated virtual reality environment.

In certain embodiments, the virtual reality headset has stored in the memory executable instructions of an executable virtual reality application which, when executed by the processor of the virtual reality headset, generates and updates the virtual reality environment.

In certain embodiments, the virtual reality headset receives, from the sensor system, calibration data indicative of a plurality of positional points in a real-world environment defining a plurality of points in the virtual reality environment, wherein the processor of the virtual reality headset generates the virtual reality environment based on the calibration data.

In certain embodiments, the weapon is retrofitted with an apparatus configured to generate a recoil force in response to a trigger of the weapon being activated by the user to simulate the firing of a projectile.

In certain embodiments, the accelerometer of the sensor system is configured to sense the recoil force, wherein the processor of the virtual reality headset is configured to update the virtual reality environment to display a firing of the weapon in the virtual reality environment.

In certain embodiments, the apparatus includes a pressurised gas source which acts against a bolt of the weapon in response to activation of the weapon to generate the recoil force.

In certain embodiments, the apparatus includes a solenoid which is electrically activated to act against a bolt of the weapon in response to activation of the weapon to generate the recoil force.

In certain embodiments, the sensor system of the weapon includes a capacitive sensor to sense the user gripping the weapon, wherein the sensor data transferred to the virtual reality headset is indicative of the user gripping the weapon, wherein the virtual reality headset is configured to update the display of the virtual reality headset to present the weapon being gripped in response to the sensor data being indicative of the user gripping the weapon.

In certain embodiments, the sensor system includes a safety catch switch, wherein the one or more sensor signals includes a safety catch switch signal indicative of a user moving a safety catch of the weapon to a released position.

In certain embodiments, the sensor system includes a trigger switch, wherein the one or more sensor signals includes a trigger switch signal indicative of a user pulling a trigger of the weapon.

In certain embodiments, at least some of the sensor system is releasably mounted via a mounting device to the weapon via a rail system of the weapon.

In certain embodiments, the mounting device includes a clamping mechanism to releasably secure at least some of the sensor system to the rail system of the weapon.

In certain embodiments, the sensor system is a distributed system including a first sensor subsystem and a second sensor subsystem, wherein the first sensor subsystem is coupled to the weapon and the second sensor subsystem is coupled to the user.

In certain embodiments, the second sensor subsystem is coupled to the user's wrist.

In certain embodiments, the first sensor subsystem includes the gyroscope, the accelerometer, and the communication interface, and the second sensor subsystem includes the positional sensor, a further gyroscope, a further accelerometer, and a further communication interface, wherein the communication interface and the further communication interface wirelessly transfer a first portion and second portion of sensor data to the virtual reality headset respectively.

In certain embodiments, the virtual reality system further comprises: a second weapon; a second sensor system, coupled to the second weapon, including: a positional sensor; a gyroscope; an accelerometer; and a wireless communication interface, wherein the second sensor system is configured to receive, from the positional sensor, the gyroscope and/or the accelerometer, one or more sensor signals and wirelessly transfer sensor data; and a second virtual reality headset worn by a second user associated with the second weapon, including a processor, a memory, a display, an accelerometer, a positional sensor, and a wireless communication interface in communication with the second sensor system; wherein the memory of the second virtual reality headset includes executable instructions which, when executed by the processor of the second virtual reality headset, configure the second virtual reality headset to: present the virtual reality environment via the display to the second user; receive, from the second sensor system via the wireless communication interface of the second virtual reality headset, second sensor data; and update, via the display and based on the second sensor data, presentation of the virtual reality environment to the second user.

In certain embodiments, the virtual reality system further includes a control processing device configured to establish a wireless network which allows the virtual reality headset and second virtual reality headset to communicate wirelessly with the control processing system.

In certain embodiments, the wireless network utilises a wireless network protocol from IEEE 802.11 family of wireless network protocols.

In certain embodiments, the communication interface of the sensor system and the second sensor system is configured to communicate with the virtual reality headset using a different wireless network compared to communication with the control processing system.

In certain embodiments, the communication interface of the sensor system and the second sensor system communicate with the virtual reality headset utilising IEEE 802.15.1 protocol.

In certain embodiments, the control processing system is a tablet computing device.

In certain embodiments, the control processing system has stored in memory an executable virtual reality application which when executed by the tablet processing system configures a display of the tablet processing system to present a control interface to allow a trainer to select, via an input device of the tablet processing system, a training scenario for the user wearing the virtual reality headset and the second user wearing the second virtual reality headset.

In certain embodiments, the control processing system is configured to relay virtual reality data between the virtual reality headset and the second virtual reality headset, wherein: the virtual reality headset is configured to update presentation of the virtual reality environment presented to the user based on the virtual reality data received from the second virtual reality headset; and/or the second virtual reality headset is configured to update presentation of the virtual reality environment presented to the second user based on the virtual reality data received from the virtual reality headset.

In certain embodiments, the virtual reality data is indicative of positional and orientation data associated with the virtual reality environment, wherein the control processing system is configured to regenerate the virtual reality environment based on the virtual reality data and present a view of the regenerated virtual reality environment.

In certain embodiments, the virtual reality data is temporally dependent to allow the virtual reality environment to be regenerated according to time.

In certain embodiments, the control processing system is configured to store the virtual reality data in at least one of: the memory of the control processing system; and memory of a remote processing system.

In certain embodiments, the control processing system is configured to determine, based on the received virtual reality data, whether a firing path of the weapon of the user intersects with a virtual reality representation of the second user in the virtual reality environment and/or whether a firing path of path of the second weapon of the second user intersects with a virtual reality representation of the user in the virtual reality environment.

In certain embodiments, the virtual reality headset has stored in the memory executable instructions to execute a first instance of an executable virtual reality application to generate and update the virtual reality environment for the virtual reality headset, and wherein the second virtual reality headset has stored in the memory executable instructions to execute a second instance of the executable virtual reality application to generate and update the virtual reality environment for the second virtual reality headset.

In certain embodiments, the virtual reality headset is configured to receive, from the sensor system, calibration data indicative of a plurality of positional points in a real-world environment defining a plurality of points in the virtual reality environment, wherein the processor of the virtual reality headset is configured to generate the virtual reality environment based on the calibration data, wherein the second virtual reality headset is configured to receive, from the second sensor system, second calibration data indicative of a plurality of positional points in the real-world environment defining a plurality of points in the virtual reality environment, wherein the processor of the second virtual reality headset is configured to generate the virtual reality environment based on the second calibration data.

In certain embodiments, the weapon is retrofitted with an apparatus configured to generate a recoil force in response to a trigger of the weapon being activated by the user to simulate firing of the weapon, and wherein the second weapon is retrofitted with a second apparatus configured to generate a recoil force in response a trigger of the second weapon being activated by the second user and simulate firing of the second weapon.

In certain embodiments, the accelerometer of the sensor system is configured to sense the recoil force generated by the apparatus, wherein the processor of the virtual reality headset is configured to update the virtual reality environment to display a firing of the weapon in the virtual reality environment, wherein the accelerometer of the second sensor system is configured to sense the recoil force generated by the second apparatus, wherein the processor of the second virtual reality headset is configured to update the virtual reality environment to display a firing of the second weapon in the virtual reality environment.

In certain embodiments, the apparatus includes a pressurised gas source which acts against a bolt of the weapon in response to activation of the weapon to generate the recoil force, and wherein the second apparatus includes a second pressurised gas source which acts against a bolt of the second weapon in response to activation of the second weapon to generate the recoil force.

In certain embodiments, the apparatus includes a solenoid which is electrically activated to act against a bolt of the weapon in response to activation of the weapon to generate the recoil force, and wherein the second apparatus includes a solenoid which is electrically activated to act against a bolt of the second weapon in response to activation of the second weapon to generate the recoil force.

In certain embodiments, the sensor system of the weapon includes a capacitive sensor to sense the user gripping the weapon, wherein the sensor data transferred to the virtual reality headset is indicative of the user gripping the weapon, wherein the virtual reality headset is configured to update the display of the virtual reality headset to present the weapon being gripped in response to the sensor data, wherein the second sensor system of the second weapon includes a second capacitive sensor to sense the second user gripping the second weapon, wherein the sensor data transferred to the second virtual reality headset is indicative of the second user gripping the second weapon, wherein the second virtual reality headset is configured to update the display of the second virtual reality headset to present the second weapon being gripped in response to the sensor data.

In certain embodiments, the sensor system includes a safety catch switch, wherein the one or more sensor signals includes a safety catch switch signal indicative of the user moving a safety catch of the weapon to a released position, wherein the second sensor system includes a safety catch switch, wherein the one or more sensor signals obtained by the second sensor system includes a safety catch switch signal indicative of the second user moving a safety catch of the second weapon to a released position.

In certain embodiments, the sensor system includes a trigger switch, wherein the one or more sensor signals obtained by the sensor system includes a trigger switch signal indicative of a user pulling a trigger of the weapon, wherein the second sensor system includes a trigger switch, wherein the one or more sensor signals obtained by the second sensor system includes a trigger switch signal indicative of a user pulling a trigger of the second weapon.

In certain embodiments, at least some of the sensor system is releasably mounted via a mounting device to the weapon via a rail system of the weapon, wherein at least some of the second sensor system is releasably mounted via a second mounting device to the second weapon via a rail system of the second weapon.

In certain embodiments, the mounting device includes a clamping mechanism to releasably secure at least some of the sensor system to the rail system of the weapon, wherein the second mounting device includes a clamping mechanism to releasably secure at least some of the second sensor system to the rail system of the second weapon.

In certain embodiments, the sensor system is a distributed system including a first sensor subsystem and a second sensor subsystem, wherein the first sensor subsystem is coupled to the weapon and the second sensor subsystem is coupled to the user, wherein the second sensor system is a distributed system including a further first sensor subsystem and a further second sensor subsystem, wherein the further first sensor subsystem is coupled to the second weapon and the further second sensor subsystem is coupled to the second user.

In certain embodiments, the second sensor subsystem is coupled to the user's wrist, and wherein the further second sensor subsystem is coupled to the second user's wrist.

Other aspects and embodiments will be appreciated throughout the detailed description.

### BRIEF DESCRIPTION OF THE FIGURES

The invention is described, by way of non-limiting example only, by reference to the accompanying figures.

FIG. 1 is a system diagram representing an example virtual reality system.

FIG. 2 is a flowchart representing an example method performed by a processor of a headset of the virtual reality system.

FIG. 3 is a system diagram of a further example of a virtual reality system.

FIG. 4 is a schematic of an example of a sensor system of FIG. 1 mountable to a weapon.

FIG. 5 is a schematic of the sensor system mounted to a rail of a weapon.

FIG. 6 shows a sectional view of an example of a bolt assembly located within a weapon in an idle position.

FIG. 7 shows a sectional view of the bolt assembly of FIG. 6 located within the weapon in a release position.

FIG. 8 shows a sectional view of the bolt assembly of FIG. 6 located within the weapon in a switch position.

FIG. 9 shows a sectional view of the bolt assembly located within the weapon in a reset position.

FIG. 10 shows a sectional view of another example of a bolt assembly located within a weapon in an idle position.

FIG. 11 shows a sectional view of the bolt assembly of FIG. 10 located within the weapon in a switch position.

FIG. 12 shows a functional block diagram of a distributed sensor system.

FIG. 13 shows a functional block diagram of a control processing system.

FIG. 14 shows a functional block diagram of the virtual reality system for multiple users.

FIG. 15 is a schematic of the control processing system presenting a user interface showing a view of a virtual reality environment for a selected training scenario.

FIG. 16 is a schematic of the control processing system presenting a user interface showing various scenarios for training a user.

FIG. 17 is a schematic showing a user wearing a virtual reality headset, wrist sensor and holding a weapon.

### DETAILED DESCRIPTION

The following modes, given by way of example only, are described to provide a more precise understanding of the subject matter of a preferred embodiment or embodiments. In the figures, incorporated to illustrate features of an example embodiment, like reference numerals are used to identify like parts throughout the figures.

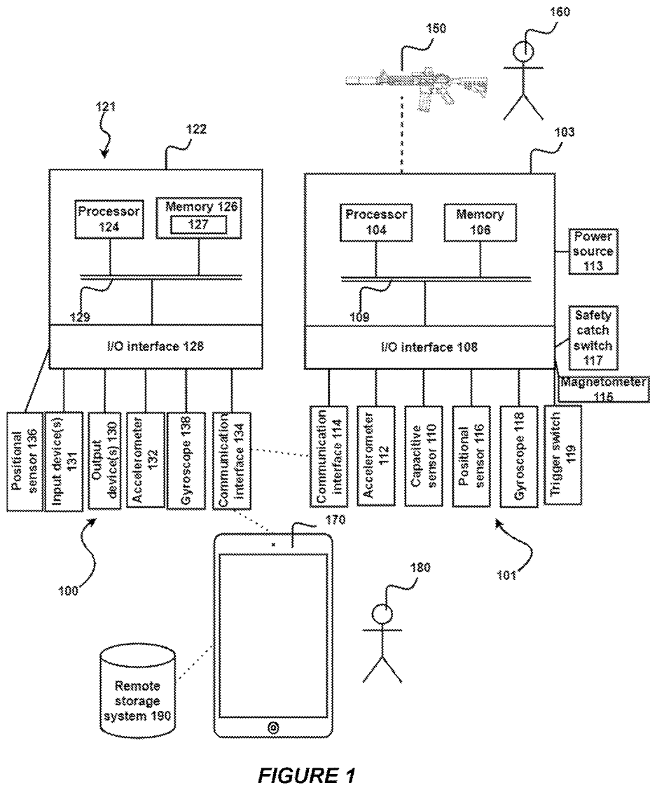

Referring to FIG. 1 there is shown an example of a virtual reality system 100. The system 100 includes a piece of equipment 150, a sensor system 101, and a virtual reality headset 121.

In one form, equipment is a weapon 150 which is a normal projectile based weapon capable of firing a projectile but is configured to not fire a projectile. For example, the weapon 150 can be an assault rifle. In other examples, the weapon 150 is a handgun. In other scenarios, the weapon may be a conductive energy device. In other scenarios, the weapon 150 may be a training weapon which is not capable of firing a projectile, such as a baton, OC spray/pepper spray, or the like. The weapon 150 is associated with a user 160, for example the weapon 150 may be held by the user 160 or may be holstered to the user 160. It will be appreciated that the equipment could take other forms for other types of scenarios such as an emergency tool for emergency personnel, such as firehoses, medical, accident/crash recovery equipment, and the like. For the sake of clarity, the examples described herein will focus on the equipment being a weapon, however it will be appreciated that various examples described herein can equally apply to other forms of equipment which are not a weapon.

The sensor system 101 is coupled to the weapon 150 and/or the user 160. The sensor system 101 includes a positional sensor 116, an accelerometer 112, a gyroscope 118, and a wireless communication interface 114. In one form, the wireless communication interface 114 utilises the IEEE 802.15.1 protocol (e.g., Bluetooth). The sensor system 101 is configured to obtain from the positional sensor 116, the gyroscope 118 and/or the accelerometer 112, one or more sensor signals and wirelessly transfer sensor data. The one or more sensor signals can include three-dimensional coordinate data (e.g., x, y and z coordinates) and/or acceleration data. In a preferable form, the sensor system includes a microcontroller 103 which includes an input output (i/o) interface 108, wherein the positional sensor 116, the accelerometer 112, the gyroscope 118 and the wireless communication interface 114 are in communication with the microcontroller 103 via the i/o interface 108. The microcontroller 103 includes a processor 104, a memory 106 and the i/o interface 108 which are coupled together via a bus 109. The memory 106 has stored therein executable instructions which when executed by the processor 104 cause the sensor system 101 to obtain one or more sensor signals and transfer sensor data via the wireless communication interface 114 to the virtual reality headset 121. In one example, the sensor system 101 can additionally include a magnetometer 115 for use in generating orientation data. In one example, the sensor system 121 can be a XIAO nRF52840 board which includes an Inertial Measurement Unit (IMU) including the accelerometer 112 and the gyroscope 118. Based on the accelerometer 112, the gyroscope 118 and the magnetometer 115, nine degrees of freedom (DOF) can be determined by the sensor system 101.

In instances where the weapon 150 is has a safety catch, the sensor system 101 includes a safety catch switch 117. The one or more sensor signals obtained by the sensor system 101 can include a safety catch switch signal, generated by the safety catch switch 117, indicative of a user 160 moving the safety catch of the weapon 150 to a released position which causes the safety catch switch 117 to be switched.

In instances where the weapon 150 includes a trigger, the sensor system 101 can include a trigger switch 119. The one or more sensor signals obtained by the sensor system 101 include a trigger switch signal generated by the trigger switch 119 indicative of a user pulling the trigger of the weapon 150 which causes the trigger switch 119 to be switched.

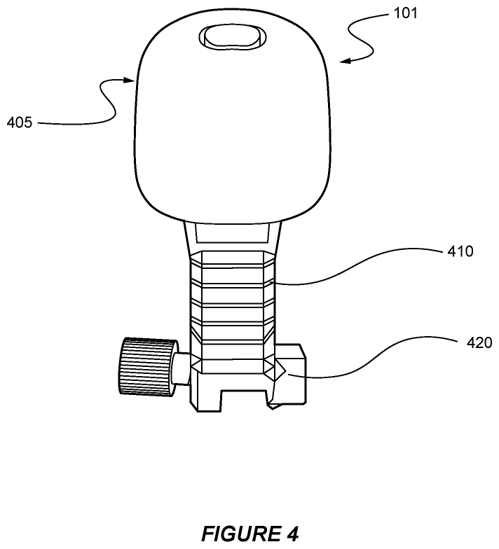

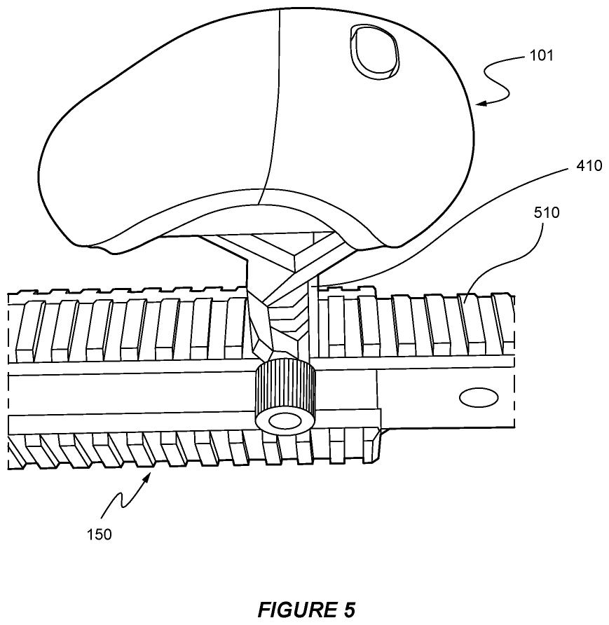

In one form, at least a part of the sensor system 101 can be releasably coupled to the weapon 150 as shown in FIGS. 4 and 5. For example, the positional sensor 116 and gyroscope 118 can be contained in a housing 405 which is releasably mounted via a mounting device 410 to a rail system 510, such as a Picatinny rail system, of the weapon 150. In a preferable form, the mounting device 410 includes a clamping mechanism 420 to releasably secure the positional sensor 116 and gyroscope 118 to the rail system 510 of the weapon 150. Other parts of the sensor system 101 may be inserted within the weapon 150. For example, as discussed below, the sensor system 101 may include a capacitive sensor 110 which is inserted into the handle portion of the weapon 150 to sense gripping of the weapon 150 by the user 160.

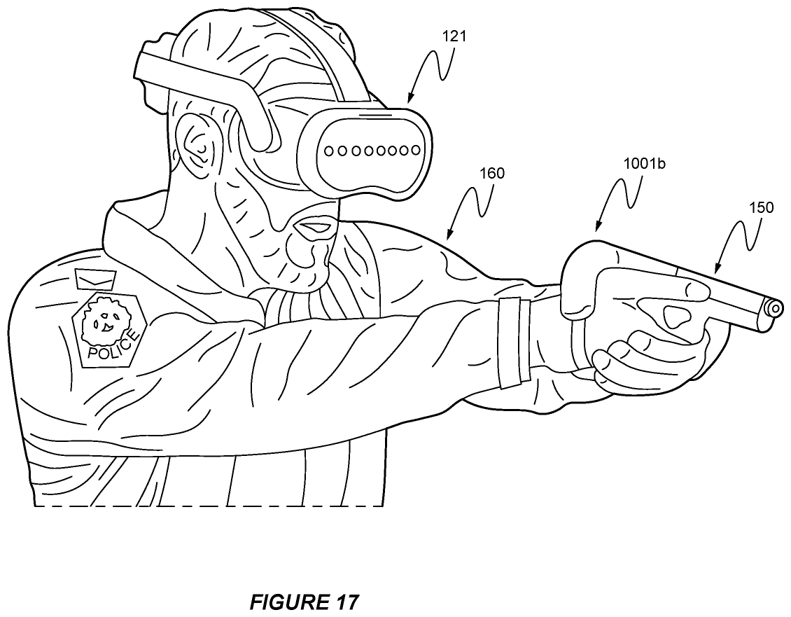

In other examples, the sensor system 121 can be a distributed system including a first sensor subsystem 1001a and a second sensor subsystem 1001b. The first sensor subsystem 1001a is coupled to the weapon and the second sensor subsystem 1001b is coupled to the user. The first sensor subsystem 1001a can include the accelerometer 112, the gyroscope 118, and a first wireless communication device 114 of the wireless communication interface of the sensor system 101. The second sensor subsystem 1001b can be coupled to the user's wrist. An example of the second sensor subsystem 1001b attached to the user's wrist can be seen in FIG. 17. The second sensor system 1001b can include the positional sensor 1116 as well as a further accelerometer 1112, a further gyroscope 1118 and a second wireless communication device 1114 of the wireless communication interface of the sensor system 101. The first and second sensor subsystems are powered by independent power sources 113, 1113. Advantageously, sensors of the sensor system 101 are distributed to allow for movement of the user and weapon to be determined independently. For example, a user may perform an action with a hand whilst not holding the weapon. By utilising the second sensor subsystem 1001b, this movement of the user's hand can be determined and then presented within the virtual reality environment by the virtual reality headset 121 without showing the weapon. In other examples, the user may be gripping the weapon 150 and the correspondence in the sensor data received from the first and second sensor subsystems 1001a, 1001b allows for a determination by the virtual reality headset 121 that the user is gripping the weapon in their hand.

In certain embodiments, the sensor system 101 coupled to the weapon 150 can include a capacitive sensor 110 to sense the user gripping the weapon 150. This is advantageous as it allows the user's virtual representation in the virtual reality environment to be updated by an executable virtual reality application to be gripping a virtual representation of the weapon 150 in response to sensor data. The capacitive sensor 110 can be located in the handle of the weapon 150 to allow sensing of the gripping action by the user. The capacitive sensor 110 can be provided in the form of a wire that extends between the i/o interface of the microcontroller of the sensor system to a nut which is wrapped in conductive tape. A screw is located in the handle of the weapon 150 and cooperates with the nut so that when the user grips the handle of the weapon 150, the user's hand comes into contact with the screw which in turn activates the capacitive detection by the microcontroller of the sensor system 101.

The sensor system 101 can be coupled to an electrical power supply. In one form, the electrical power supply 113 can be provided in the form of a battery. In one example, the one or more batteries can be provided in the form of one or more lithium-polymer (LiPo) batteries, such as a 3.7V, 400 mAh battery pack. The one or more batteries can be rechargeable batteries. In one form, the one or more batteries are electrically coupled to the microcontroller 103 of the sensor system 101, wherein the microcontroller 103 includes an electrical charging port to allow an external power source to recharge the one or more batteries. In one form, the electrical charging port can be provided in the form of a Universal Serial Bus (USB) port such as a USB-C port. The electrical charging port can be exposed in the housing of the weapon to allow for electrical coupling with a charging device. The one or more batteries can be located within a cavity provided in the handle of the weapon.

The virtual reality headset 121 is worn by the user 160 associated with the weapon 150. The virtual reality headset 121 includes a processor 124, a memory 126, one or more output devices 130 such as a display and speakers, an accelerometer 132, a gyroscope 133, a positional sensor 136, and a wireless communication interface 134 in communication with the sensor system 101. The virtual reality headset 121 can also include one or more input devices 131 such as various a microphone or buttons on the housing of the virtual reality headset. The virtual reality headset 121 includes a controller 122 providing the processor 124, the memory 126 and an input/output (i/o) interface 128 coupled together via a bus 129.

In one form, the microphone 131 can capture audio data of the user. The audio data can be transferred to be recorded and then used in later playback of the training scenario at a control processing system 170 as discussed below.

The communication interface of the virtual reality headset 121 communicates using two different wireless protocols. In particular, communication of the sensor data received from the sensor system utilises the IEEE 802.15.1 protocol (e.g., Bluetooth). As explained in further detail below, communication of the virtual reality headset with a control processing system utilises a protocol of the IEEE 802.11 standard (e.g., Wi-Fi).

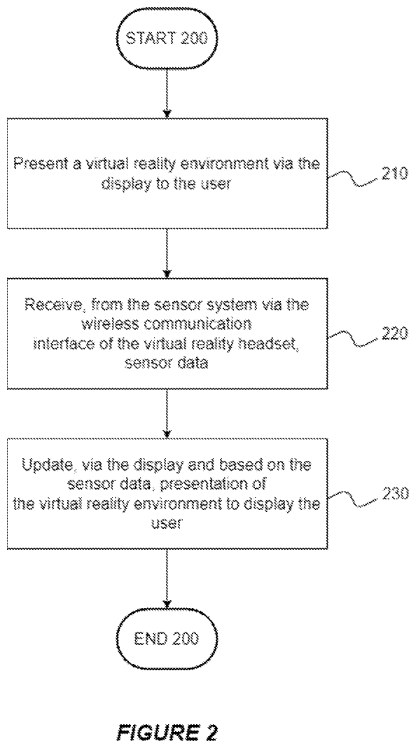

The memory 126 of the virtual reality headset 121 includes executable instructions which when executed by the processor 124 of the virtual reality headset 121, configure the processor 124 of the virtual reality headset 121 to perform a method 200 as shown in FIG. 2. In a preferable form, the executable instructions execute an instance of a executable virtual reality application to generate, control and update the virtual reality environment. The virtual reality environment includes the virtual surroundings as well as one or more virtual characters/representations including those representing the one or more users 160 of the system. In one form, the instance of the executable virtual reality application can be based on the Unity game engine.

In a preferable form, the virtual reality headset 121 includes an accelerometer 132 and a gyroscope 138. Thus, movement of the user's head which is wearing the respective headset 121 can be detected based on one or more sensor signals obtained by the processor of the virtual reality headset from the accelerometer 132 and/or gyroscope 138 such that the processor 124 of the virtual reality headset 121 is configured to update the virtual reality environment based on one or more sensor signals received from the accelerometer 132 and gyroscope 138 of the headset 121.

In one form, the processor 104 of the sensor system 101 or the processor 124 of the virtual reality headset 121 is configured to detect the simulated firing of the weapon 150 based on one or more sensor signals received from the accelerometer 112. In one form, the recoil force is sensed by the accelerometer 112 which is classified as a firing of the weapon 150. The classification of the one or more sensor signals received from the accelerometer 112 can be performed using a machine trained model. Executable instructions representing the machine trained model are stored in the memory 106 of the sensor system 101 or memory of the virtual reality headset, wherein the one or more signals received from the accelerometer 112 are provided as input to the machine trained model, and an output is generated indicative of whether the one or more sensor signals are classified as a firing of the weapon 150.

As shown in FIG. 1, the system 100 can also include a control processing device 170 configured to establish a wireless network which allows the virtual reality headset 121 to communicate wirelessly with the control processing system 170. The control processing system operates as a wireless network access point, establishing and controlling the wireless network. The control processing system includes a communication interface which utilises the IEEE 802.11 family of wireless network protocols (e.g., Wi-Fi).

The control processing system 170 can be provided in the form of a tablet computing device, although other processing systems are possible. The tablet processing system 170 is preferable as the system is highly portable. In this embodiment, the control processing system 170 operates as an access point of the wireless network. In a preferable form, the wireless network is a Wi-Fi network.

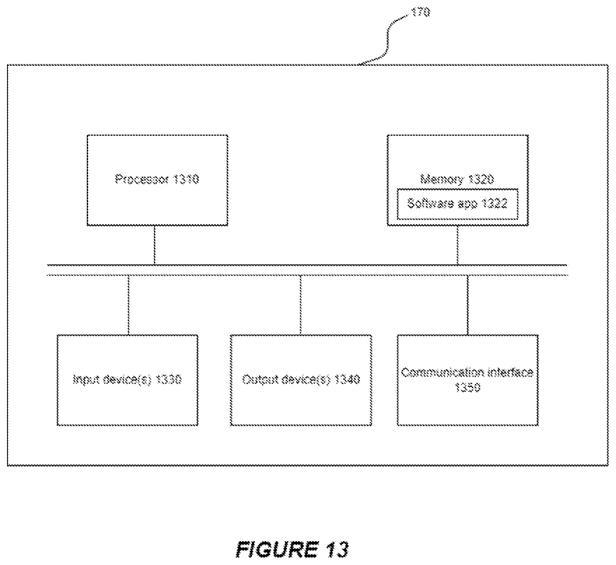

Referring to FIG. 13, there is shown a functional block diagram of the control processing system 170. The control processing system 170 includes a processor 1310, a memory 1320, an input device 1330, an output device 1340, and a communication interface 1350. The input and output device 1330, 1340 can be provided as a single input/output device such as a touch screen interface. The control processing system 170 has stored in the memory 1320 a software application 1360 which when executed by the tablet processing system 170 configures a display of the tablet processing system to present a control interface to allow a trainer to select a training scenario to be simulated in the virtual reality environment for the user 160 wearing the virtual reality headset 121. In this situation, the system 100 can operate as a virtual reality weapon training system. The control processing system 170 can operate without an Internet connection. This advantageously allows for the virtual reality system 100 to be extremely portable and operate in various locations where one or more users may require training. The software application 1360 is configured similarly to the virtual reality application 127 of the virtual reality headset 121 in that the software application 1360 includes a virtual reality generation module which regenerates the virtual reality environment based on the virtual reality data received from the virtual reality headset 121. However, as the control processing system is not a virtual reality headset, there are slight differences in the software applications that are executed by the virtual reality headset 121 and the control processing system 170.

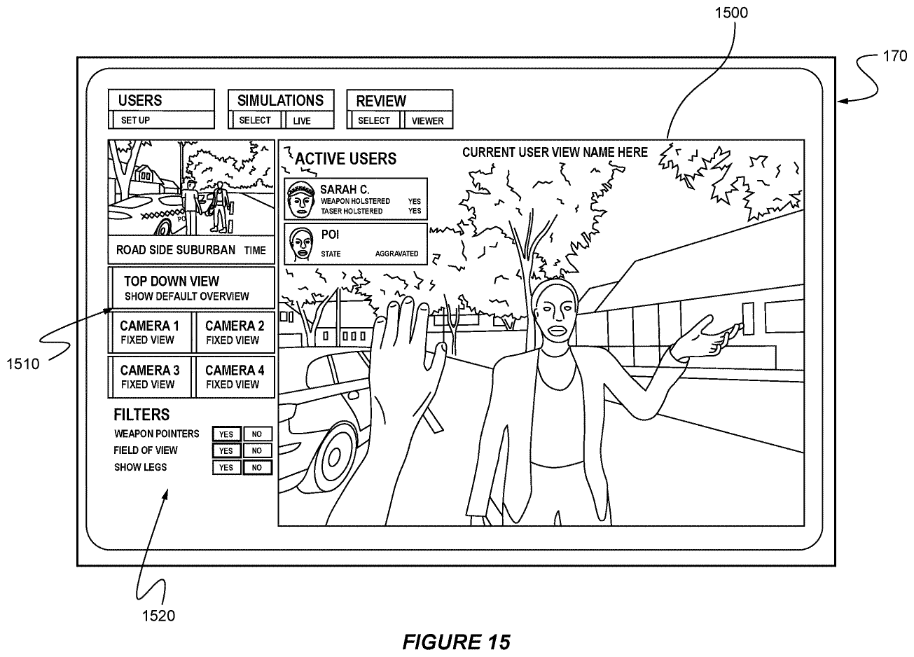

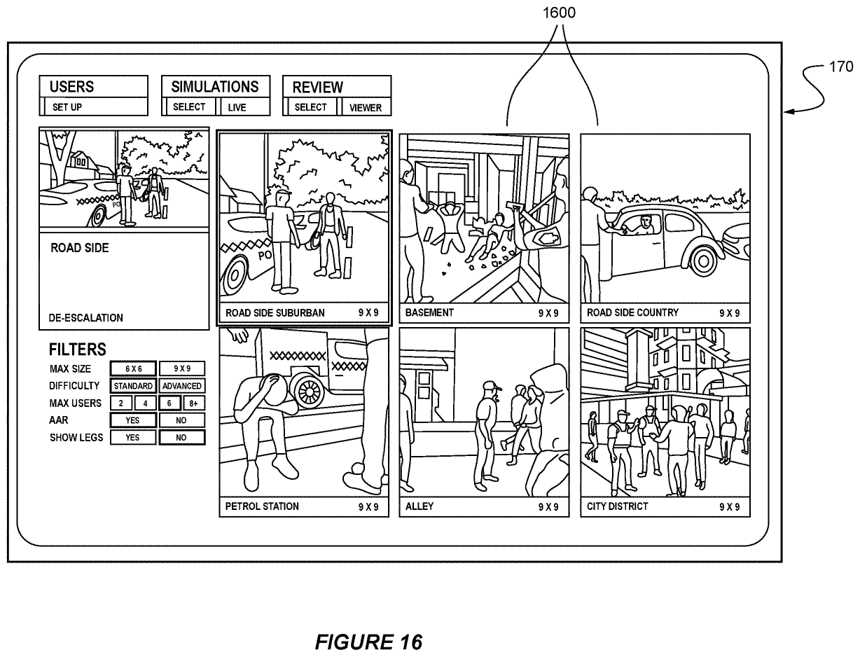

Referring to FIGS. 15 and 16 there is shown a schematic of an example of a control processing system presenting a user interface of the software application 1360. In FIG. 15, the schematic shows a main window of the user interface which presents a particular view of the virtual reality environment. The trainer is able to interact with the user interface to select a particular user view to view the virtual reality environment. The trainer is also able to select to view the virtual reality environment from different angles which may not correspond to a particular user view within the virtual reality environment. This feature is particularly advantageous for reviewing a scenario which has already been completed as it may allow the trainer to provide an alternate view for the trained user to help improve technique or the like. FIG. 16 shows the user interface of the software application 1360 which allows the trainer to select one scenario from multiple training scenarios for the user(s) to perform within. Once the scenario has been selected, data indicative of the selected scenario is transferred by the control processing system 170 to each virtual reality headset 121 so that each executable virtual reality application generates the same virtual reality environment.

The control processing system 170 in FIG. 1 can be configured to receive and store virtual reality data from the virtual reality headset. The virtual reality data can include positional and orientation/rotation data to allow for the virtual reality environment to be recreated by the control processing system 170. The virtual reality data can additionally include events that have occurred in the virtual reality environment. The executable software application stored in memory of the control processing system 170 is configured to regenerate the virtual reality environment using the virtual reality data received from the virtual reality headset 121. A view of the virtual reality environment can then be presented via the display of the control processing system 170. Thus, a trainer 180 operating the control processing system 170 can view the virtual reality environment that is being viewed by the user 160. The control processing system 170 can be configured to store the virtual reality data in a non-volatile manner in the memory of the control processing system.

Additionally or alternatively, the control processing system 170 can store the virtual reality data in memory of a remote storage system 190, such as a cloud processing system. The trainer 180 can then interact with the control processing system 170 to playback the stored scenario by regenerating the virtual reality environment using the stored virtual reality data. Advantageously, the trainer can select different camera angles to present the regenerated virtual reality environment, thereby allowing the trainer or the user to see the training scenario from a different perspective to improve their technique of the task being trained.

Advantageously, the virtual reality data has a significantly more efficient memory footprint compared to video content. Furthermore, regenerating the virtual reality environment using the virtual reality data provides more flexibility in terms of allowing for different perspectives to be viewed. The virtual reality data is time dependent. For example, each virtual reality headset can be configured to transfer virtual reality data to the control processing system in a periodic manner, thereby making the virtual reality data temporally dependent.

Alternatively, the virtual reality data received may be timestamped such that periodic transfer of the virtual reality data is not necessary. Audio data can additionally be received by the control processing system 170 and stored. The audio data captured by the microphone can be time-dependent such that audio playback can be synchronised with the regenerated virtual reality environment when presented via the control processing system 170. The audio data can be stored together with the virtual reality data.

In certain forms, the weapon 150 is capable of firing a projectile, however the weapon 150 is retrofitted with an apparatus to prevent firing of the projectile, but the apparatus is configured to simulate a recoil force in response to a trigger of the weapon 150 being activated by the user 160. In one form, the accelerometer 112 of the sensor system 101 senses the recoil forces as a detected firing of the weapon 150, wherein the processor 124 of the virtual reality headset 121 is configured to update the virtual reality environment to display a firing of the weapon 150 in the virtual reality environment.

In one form, the apparatus is a gas-powered simulated recoil system. The activation of the trigger results in a controlled release of compressed gas to act on the gun's bolt or slide to simulate a recoil force which is sensed by the accelerometer as a simulated firing of the weapon. In one form, the gas-powered simulated recoil system is available from Dvorak Instruments Inc., 9402 E. 55th St, Tulsa, OK 74145, United States of America.

In another form, the apparatus includes a solenoid which is electrically activated to act against a bolt of the weapon in response to activation of the weapon to generate the recoil force. In one form, the apparatus may be provided in the form of a bolt carrier group trigger resetter as described in PCT Application No. PCT/US2021/049174 which is herein incorporated by reference in its entirety.

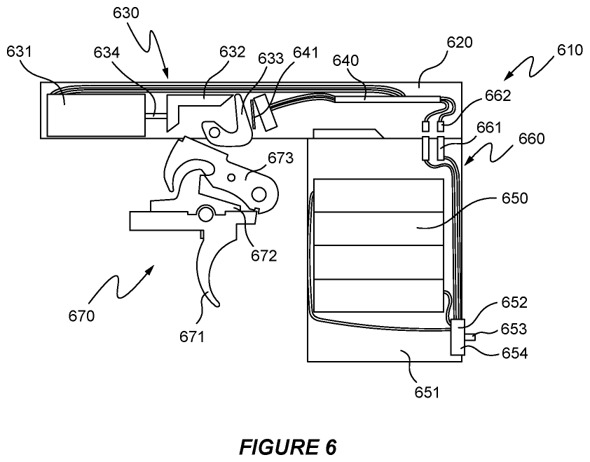

In another form, the apparatus may be provided in the form of a bolt assembly as illustrated in FIGS. 6 to 11 and as described below which is considered suitable for an assault rifle.

FIG. 6 shows a schematic representation of the bolt assembly 610 located within a firing chamber of a weapon (not shown). The bolt assembly 610 is designed to replace the bolt carrier in a service assault weapon such as an M4. The bolt assembly 610 includes a bolt body 620, trigger reset mechanism 630 and microcontroller 640.

The bolt body 620 is made from metal, such as stainless steel or aluminium, and shaped to largely to replicate the external dimensions of a bolt carrier specific to the weapon. Accordingly, the bolt body will fit easily into the firing chamber of the weapon. The bolt body 620 is located above a trigger mechanism 670.

The bolt body 620 is used to mount the trigger reset mechanism 630. The trigger reset mechanism is formed from a solenoid 631, lever 632 and cam 633. The solenoid 631 is mounted at one end of the bolt body 620 and includes a piston 634. The piston 634 is attached to the lever 632. The cam 633 is pivotally mounted to the bolt body 620 and is located adjacent to the lever 632. The piston 634 of the solenoid 631 is able to be moved between a retracted position and an extended position.

The microcontroller 640 is located adjacent the cam 633. In one form, the microcontroller 640 is an Arduino microcontroller The microcontroller 640 is connected to a sensor 641 and Bluetooth transmitter (not shown). The sensor 641 is a mechanical microswitch that is movable between a depressed position and an open position relative to the movement of the cam.

A power source, in the form of a battery 650, is located within a magazine shaped casing 651. The battery 650 has four cells and is used to supply power to the microcontroller 640 (and hence the sensor and transmitter) and the solenoid via a wiring circuit 660. The wiring circuit 660 includes both battery terminals 661 and bolt terminals 662 to releasably connect the battery 650 to the microcontroller 640 and the solenoid 631. The battery 650 has a charging port 652, on/off switch 653 and associated LEDs 654 to indicate when the battery is being charged, is fully charged and is being used.

The bolt assembly 610 is positioned above a standard trigger mechanism 670 which includes a trigger 671, a sear 672 and a hammer 673. The solenoid 631 is located behind the trigger mechanism 670 in this embodiment.

In use, the bolt assembly 610 remains in an idle position as shown in FIG. 6.

The bolt assembly is ready for use once the battery is switched to an on position. In the idle position, the piston of the solenoid is in an extended position and the sensor is in an open position.

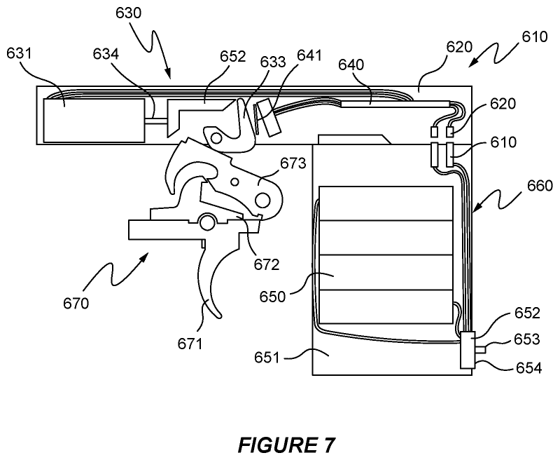

When the trigger of the trigger mechanism is pulled, the hammer is released from the sear when a trigger is pulled as shown in FIG. 7. This causes the hammer to contact the pivotally movable cam.

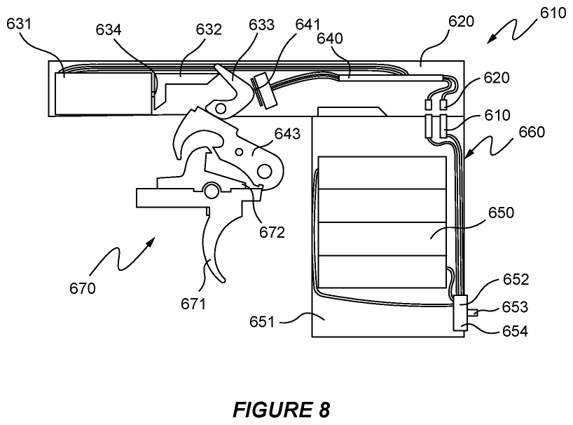

The hammer moves the cam against the lever and moves the solenoid from the extended position to the retracted position. The movement of the cam also moves the sensor from an open position to a depressed position as shown in FIG. 8. Moving the sensor from the open position to the depressed position causes the microcontroller to communicate with the transmitter to send a Bluetooth signal to an external unit such as a virtual reality headset or computer to indicate that a virtual shot has been fired.

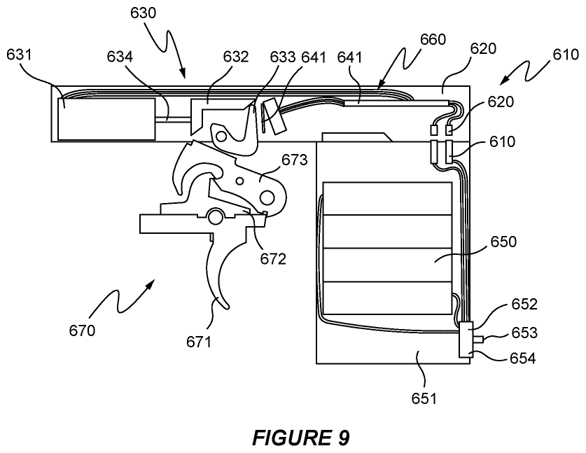

The microcontroller then also enables the solenoid to be energised. This causes the piston of the solenoid to move from the retracted position to the extended position. This causes the attached lever to push against the cam causing the cam to rotate. The rotation of the cam causes the hammer to pivot and be caught by the sear hence resetting the trigger mechanism as shown in FIG. 9. The above sequence is repeated when the trigger is again pulled.

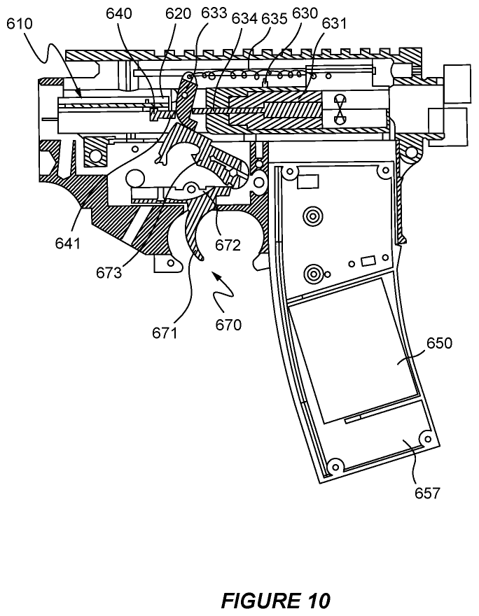

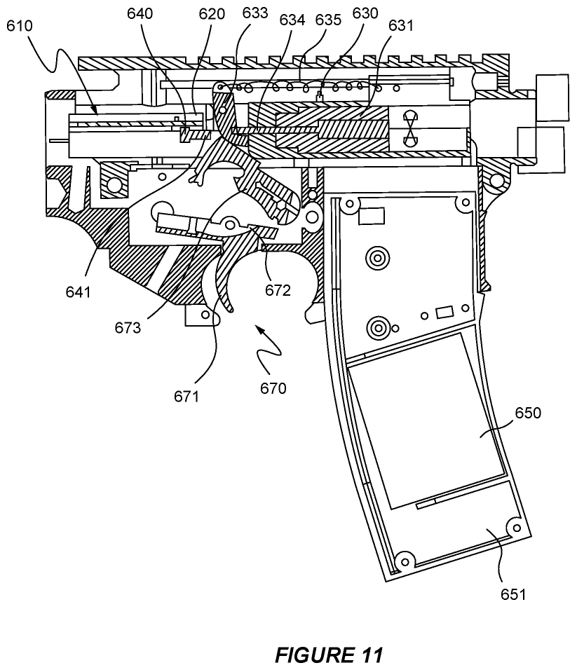

FIGS. 10 and 11 show a second embodiment of the bolt assembly 610. The bolt assembly 610 shown in FIGS. 10 and 11 is similar in design to the bolt assembly 610 shown in FIGS. 6 to 9 and hence like numbers have been used to describe like components.

The bolt assembly 610 again includes a bolt body 620, trigger reset mechanism 630 and microcontroller 640. The bolt body 620 is shaped to fit within the firing chamber of the weapon.

The bolt body 620 is used to mount the trigger rest mechanism 630. The trigger reset mechanism 630 is formed from a solenoid 631 and cam 633. The solenoid 631 is mounted to the bolt body 620 with a piston 634 of the solenoid 631 located adjacent the cam 633. The piston 634 of the solenoid 631 is able to be moved between a retracted and an extended position.

A microcontroller 640 is located adjacent the cam 633. The microcontroller 640 is connected to a sensor 641 and Bluetooth transmitter (not shown). The sensor 641 is a mechanical sensor that is movable between a depressed position and an open position relative to the movement of the cam 633.

The cam 633 is pivotally mounted to the bolt body 620 and the cam 633 is biased by a spring 635 toward the sensor 641.

A battery 650 is located within a magazine shaped casing 651 as indicated above and is wired in the same manner as discussed above. Hence, the wiring is not shown in FIGS. 10 and 11.

In use, the bolt assembly 610 remains in an idle position as shown in FIG. 10. The bolt assembly 610 is ready for use once the battery is switched to an on position. In the idle position, the solenoid piston 634 is in an extended position and the sensor is in an open position.

When the trigger 671 of the trigger mechanism 670 is pulled, the hammer is released from the sear 672 when a trigger 671 is pulled as shown in FIG. 11. This causes the hammer 673 to contact the pivotally movable cam 633.

The hammer 673 moves the cam 633 against the piston and moves the solenoid from the extended position to the retracted position. The spring 635 cushions the force of the hammer 673. The movement of the cam 633 also moves the sensor 641 from a depressed position to an open position. Moving the sensor 641 from the depressed position to the open position causes the microcontroller 640 to communicate with the transmitter to send a Bluetooth signal to an external unit such as a virtual reality headset or computer to indicate that a virtual shot has been fired.

The microcontroller then also enables the solenoid 631 to be energised. This causes the piston 634 of the solenoid 631 to move from the retracted position to the extended position. This causes the piston 634 to push against the cam causing the cam 633 to rotate. The rotation of the cam 633 causes the hammer 673 to pivot and be caught by the sear 672 hence resetting the trigger mechanism 670 as shown in FIG. 10. The above sequence is repeated when the trigger is again pulled.

The bolt assembly 610 enables an operator to use their own weapon in training. The bolt assembly 610 resets the trigger mechanism in order to give the weapon operator the same trigger pressure as when firing live rounds. The operator trains with their own weapon with no external modifications necessary. This greatly enhances virtual reality training.

Referring to FIG. 2, there is depicted a flow chart representing method 200 performed by the virtual reality headset of the virtual reality system of FIG. 1. At step 210, the method 200 includes presenting a virtual reality environment via the display 130 to the user 160. At step 220, the method 200 includes receiving, from the sensor system 101 via the wireless communication interface 134 of the virtual reality headset 121, sensor data. At step 230, the method 200 includes updating, via the display 130 and based on the sensor data, presentation of the virtual reality environment. As will be appreciated, the processor 124 is preferably executing the instance of the executable virtual reality application to present and update the virtual reality environment.

In one form, when a training session is to begin, a calibration request is transferred from the control processing system 170 to the virtual reality headset in response to the training user 180 interacting with the input device 1330 of the control processing system. The system 100 can be initialised and calibrated for a specific real-world environment. In response to receiving the calibration request and prior to generating the virtual reality environment, the virtual reality headset 121 is configured to receive, from the sensor system 101 of the weapon 150, calibration data indicative of a plurality of points in a real-world environment defining a plurality of points in the virtual reality environment. The processor 124 of the virtual reality headset 121 generates the virtual reality environment based on the calibration data. In particular, the points from the real-world environment may define corners of a virtual reality environment, wherein the processor 124 generates the virtual reality environment using the plurality of points indicated by the calibration data. The calibration data can include a position detected using the positional sensor to determine dimensions of the physical real-world environment which is used to generate the virtual reality environment.

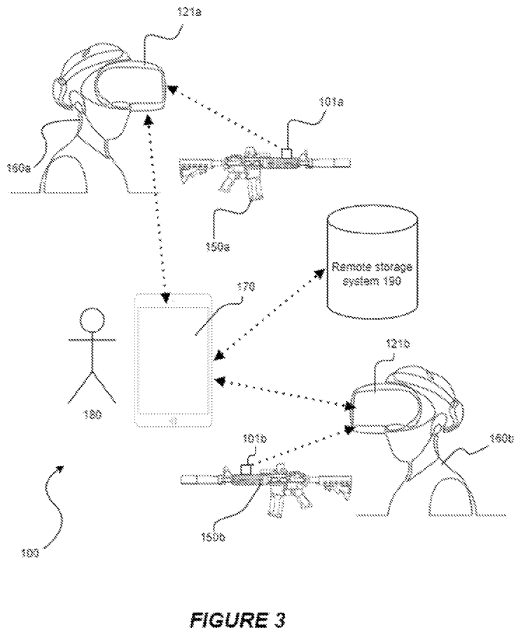

As shown in FIG. 3, there is shown a further example of the virtual reality weapon training system 100. In particular, the system 100 of FIG. 3 differs from the system 100 of FIG. 1 by including a first user 160a and a second user 160b, wherein the first user 160a has a first weapon 150a. A first sensor system 101a is coupled to the weapon and/or the first user 160a. A first virtual reality headset 121a is worn by the first user. The second user 160b has a second weapon 150b. A second sensor system 101b is coupled to the second weapon 150b and/or the second user 160b. A second virtual reality headset 121b is worn by the second user. The second weapon 150b, the second sensor system 101b and the second virtual reality headset 121b are configured in the same manner as described earlier in relation to the weapon 150, the sensor system 101 and the virtual reality headset 121 respectively as described earlier. This system 100 of FIG. 3 allows for two users to train within the same virtual reality environment. It will be appreciated that the system 100 of FIG. 3 allows for a plurality of users to train within the same virtual reality environment.

The first and second virtual reality headsets 121a, 121b are configured in the same manner as described above in relation to virtual reality headset 121.

A first instance of the executable virtual reality application 127 is stored in memory and executable by the processor of the first virtual reality headset 121a. A second instance of executable virtual reality application 127 is stored in memory of the second virtual reality headset 121b. The executable virtual reality applications 127 are preferably configured identically and effectively generate, control and update the same virtual reality environment but from different user perspectives. The first user's interaction with the virtual reality environment is shared by the first virtual reality headset 121a with the second virtual reality headset 121b via the control processing system 170. Similarly, the second user's interaction with the virtual reality environment is shared by the second virtual reality headset 121b with the first virtual reality headset 121a via the control processing system 170. As such, each instance of the executable virtual reality application 127 is using the same data to update the virtual reality environment presented to the respective user.

More specifically, in the system 100 of FIG. 3, the control processing system 170 is configured to relay virtual reality data between the first headset 121a and the second headset 121b. The first headset 121a and the second headset 121b are configured to update presentation of the virtual reality environment based on the received virtual reality data. As such, the executable virtual reality application 127 being executed by the respective headsets 121a, 121b in a multi-user system 100 are substantially synchronised due to the relaying of data by the control processing system 170. The virtual reality data can be positional and/or orientation data of the weapon 150 of the user 160, positional and/or orientation data of the user's headset 121, position and/or orientation data of the user's limb (such as the user's hand) and events that are generated within the virtual reality environment, such as a virtual reality character being shot, wherein a character shot command is transferred from one of the virtual reality headsets 121 to the other virtual reality headset 121 to play a character shot sequence.

The control processing system 170 in FIG. 3 can be configured to receive and store the virtual reality data to regenerate the virtual reality environment and present a particular view of the virtual reality environment via the display 130 of the virtual reality headsets 121a, 121b. Thus, a trainer 180 operating the control processing system 170 can view the virtual reality environment being viewed by the first user 160a, the second user 160b, in some instances both the first and second users simultaneously, and in other instances alternate camera views due to the regeneration of the virtual reality environment. The control processing system 170 can be configured to store the virtual reality data in a non-volatile manner in the memory of the control processing system 170. Additionally or alternatively, the control processing system 170 can store the virtual reality data in memory of a remote processing system 190, such as a cloud processing system, if an Internet connection is available. In some instances, audio data captured by the microphone of each virtual reality headset can be temporally synchronised with the presentation of the regenerated virtual reality environment. The audio data can be stored together with the virtual reality data. The audio data may be timestamped to allow for synchronisation with the regenerated virtual reality environment.

If multiple users 160a, 160b, . . . 160n are training in the virtual reality environment, the trainer user 180 can select one of the training users 160a, 160b, . . . 160n from an interface of the software application which results the regenerated virtual reality environment being displayed from the selected user's perspective.

In the multi-user system 100 as shown in FIG. 3, the control processing system 170 can receive data from the first virtual reality headset 121a and/or the second virtual reality headset 121b indicating whether a firing path of the first weapon 150a of the first user 160a intersects with a virtual representation of the second user 160b in the virtual reality environment and/or whether a firing path of path of the second weapon 150b of the second user 160b intersects with a virtual representation of the first user 160a in the virtual reality environment. This is advantageous as it allows for users to train with correct technique to prevent injury (accidental friendly fire) in a real-world environment.

The system 100 of FIG. 3 can be initialised and calibrated for a specific real-world environment. In particular, prior to generating the virtual reality environment, the first virtual reality headset 121a is configured to receive, from the first sensor system 101a, calibration data indicative of a plurality of points in a real-world environment defining a plurality of points in the virtual reality environment. The processor 124a of the first virtual reality headset 121a generates the virtual reality environment based on the calibration data. Similarly, the second virtual reality headset 121b is configured to receive, from the second sensor system 101b, calibration data indicative of a plurality of points in the real-world environment defining the plurality of points in the virtual reality environment. The processor 124b of the second virtual reality headset 121b generates the virtual reality environment based on the calibration data. In particular, the points from the real-world environment may define corners of a virtual reality environment, wherein the processors 124a, 124b generate the virtual reality environment using the plurality of points indicated by the calibration data.

As will be appreciated from above description, the first and second sensor systems 101a, 101b are configured in the same manner as the sensor system 101 described earlier for a single user system. Similarly, the first and second weapon 150a, 150b are configured in the same manner as the weapon 150 for a single user system. Furthermore, the first and second virtual reality headsets 121a, 121b are configured in the same manner as the virtual reality headset 121 for a single user system. However, for the sake of completeness, the first and second sensor systems, the first and second weapon 150a, 150b and the first and second virtual reality headset 121a, 121b will be described in further detail below.

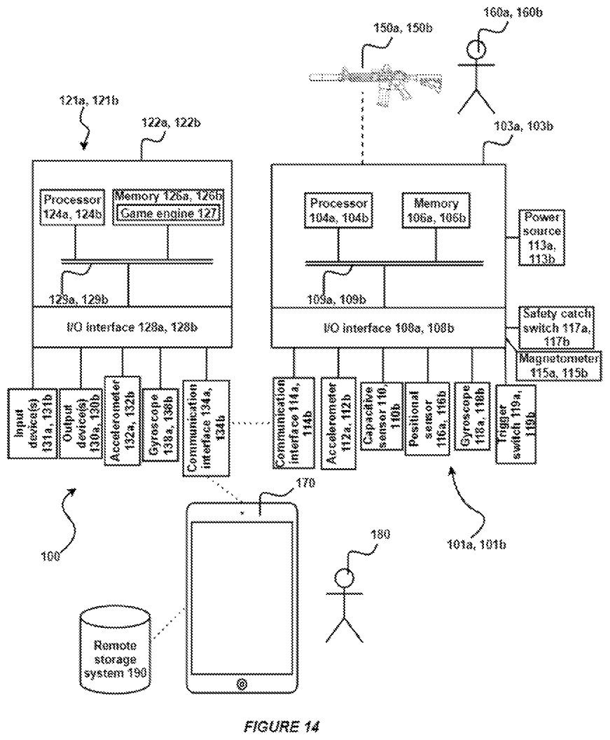

Referring to FIG. 14, the first/second sensor system 101a, 101b is coupled to the first/second weapon 150a, 150b and/or the first/second user 160a, 160b. The first/second sensor system 101 a, 101 b includes a positional sensor 116a, 116b, an accelerometer 112a, 112b, a gyroscope 118a, 118b, and a wireless communication interface 114a, 114b. In one form, the wireless communication interface 114a, 114b utilises the IEEE 802.15.1 protocol (e.g., Bluetooth). The first/second sensor system 101 a, 101 b is configured to obtain, from the positional sensor 116a, 116b, the gyroscope 118a, 118b and/or the accelerometer 112a, 112b, one or more sensor signals and wirelessly transfer sensor data. The one or more sensor signals can include various types of data such as three-dimensional coordinate data (e.g., x, y and z coordinates) and/or acceleration data. In a preferable form, the first/second sensor system 101a, 101b includes a microcontroller 103a, 103b which includes an input output (i/o) interface 108a, 108b, wherein the positional sensor 116a, 116b, the accelerometer 112a, 112b, the gyroscope 118a, 118b and the wireless communication interface 114a, 114b are in communication with the microcontroller 103a, 103b via the i/o interface 108a, 108b. The microcontroller 103a, 103b includes a processor 104a, 104b, a memory 106a, 106b and the i/o interface 108a, 108b which are coupled together via a bus 109a, 109b. The memory 106a, 106b has stored therein executable instructions which when executed by the processor 104a, 104b cause the first/second sensor system 101a, 101b to obtain one or more sensor signals and transfer sensor data via the wireless communication interface 108b to the first/second virtual reality headset 121a, 121b. In one example, the first/second sensor system 101a, 101b can additionally include a magnetometer 115a, 115b. In one example, the first/second sensor system 121a, 121b can be a XIAO nRF52840 board which includes an Inertial Measurement Unit (IMU) including the accelerometer 112a, 112b and the gyroscope 118a, 118b.

In instances where the first/second weapon 150a, 150b has a safety catch, the sensor system 101a, 101b includes a safety catch switch. The one or more sensor signals obtained by the first/second sensor system 101a, 101b can include a safety catch switch signal, generated by the safety catch switch, indicative of the first/second user 160a, 160b moving the safety catch of the first/second weapon 150a, 150b to a released position which causes the safety catch switch to be switched. In instances where the first/second weapon 150a, 150b includes a trigger, the first/second sensor system 101a, 101b includes a trigger switch. The one or more sensor signals obtained by the first/second sensor system 101a, 101b include a trigger switch signal generated by the trigger switch indicative of a user pulling the trigger of the weapon which causes the trigger switch to be switched.

In one form, at least a part of the first/second sensor system 101a, 101b can be releasably coupled to the first/second weapon 150a, 150b as shown in FIGS. 4 and 5 for the first/second sensor system 101. For example, the positional sensor 116a, 116b and gyroscope 118a, 118b can be contained in a housing 405 which is releasably mounted via a first/second mounting device 410 to a rail system 510, such as a Picatinny rail system, of the first/second weapon 150a, 150b. In a preferable form, the first/second mounting device 410 includes a clamping mechanism 420 to releasably secure the positional sensor 116a, 116b and gyroscope 118a, 118b to the rail system 510 of the first/second weapon 150a, 150b.

Other parts of the first/second sensor system 101a, 101b may be inserted within the first/second weapon 150a, 150b. For example, as discussed below, the first/second sensor system 101a, 101b may include a capacitive sensor 110a, 110b which is inserted into the handle portion of the first/second weapon 150a, 150b to sense gripping of the first/second weapon 150a, 150b by the user 160.

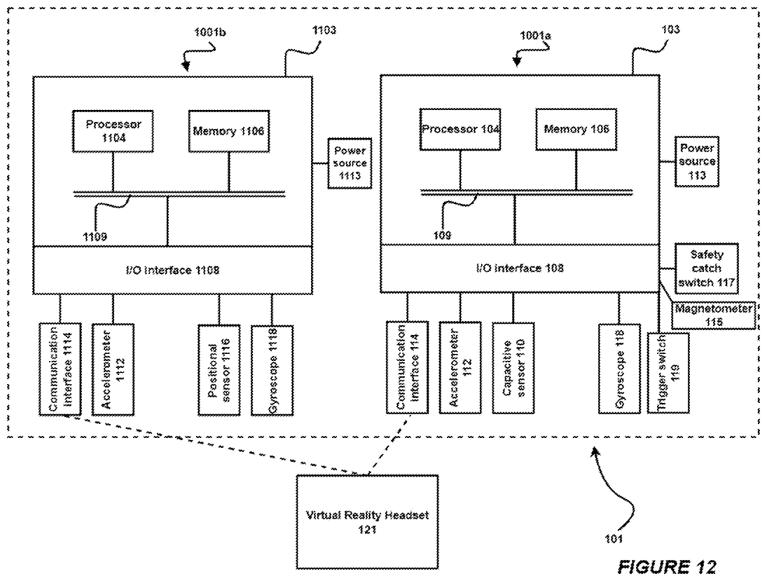

In other examples, the first/second sensor system 121a, 121b can be a distributed system including a first sensor subsystem and a second sensor subsystem as described in relation to a single user system with respect to FIG. 12.

In certain embodiments, the first/second sensor system 101a, 101b coupled to the first/second weapon 150a, 150b can include a capacitive sensor 110a, 110b to sense the user gripping the first/second weapon 150a, 150b. This is advantageous as it allows the user's virtual representation in the virtual reality environment to be updated by an executable virtual reality application 127 to grip a virtual representation of the first/second weapon 150a, 150b in response to the sensor data. The capacitive sensor 110a, 110b can be located in the handle of the first/second weapon 150a, 150b to allow sensing of the gripping action by the user. The capacitive sensor 110a, 110b can be provided in the form of a wire that extends between the i/o interface of the microcontroller 103a, 103b of the first/second sensor system 101a, 101b to a nut which is wrapped in conductive tape. A screw protrudes through and within the rear wall of the handle of the first/second weapon and cooperates with the nut so that when the first/second user grips the handle of the first/second weapon, the first/second user's hand comes into contact with a head of the screw which in turn activates the capacitive detection by the microcontroller 103a, 103b of the first/second sensor system 101a, 101b.

The first/second sensor system 101a, 101b can be electrically coupled to an electrical power supply 113a, 113b. In one form, the electrical power supply 113a, 113b can be provided in the form of one or more batteries. In one example, the one or more batteries can be provided in the form of one or more lithium-polymer (LiPo) batteries, such as a 3.7V, 400 mAh battery pack. The one or more batteries can be rechargeable batteries. In one form, the one or more batteries are electrically coupled to the microcontroller 103a, 103b of the sensor system 101a, 101b, wherein the microcontroller 103a, 103b includes an electrical charging port to allow an external power source to recharge the one or more batteries. In one form, the electrical charging port can be provided in the form of a Universal Serial Bus (USB) port such as a USB-C port. The electrical charging port can be exposed in the housing of the first/second weapon 150a, 150b to allow for electrical coupling with a charging device.

The first/second virtual reality headset 121a, 121b is worn by the first/second user 160a, 160b associated with the first/second weapon 150a, 150b. The first/second virtual reality headset 121a, 121b includes a processor 124a, 124b, a memory 126a, 126b, one or more output devices 130a, 130b such as a display and speakers, an accelerometer 132a, 132b, a gyroscope 133a, 133b, a positional sensor 136a, 136b, and a wireless communication interface 134a, 134b in communication with the first/second sensor system 101a, 101b and the control processing system 170. The first/second virtual reality headset 121a, 121b can also include one or more input devices 131 such as various a microphone or buttons on the housing of the virtual reality headset. The virtual reality headset 121a, 121b includes a controller 122a, 122b providing the processor 124a, 124b, the memory 126a, 126b and an input/output (i/o) interface 128a, 128b coupled together via a bus 129a, 129b.

Audio data captured by the microphone of each virtual reality headset 121a, 121b can be transferred to the control processing system for synchronisation with the playback of the virtual reality environment at the control processing system 170.

The communication interface 114a, 114b of the first/second virtual reality headset 121a, 121b communicates using two different wireless protocols. In particular, communication of the sensor data received from the first/second sensor system 121a, 121b utilises the IEEE 802.15.1 protocol (e.g., Bluetooth). As explained in further detail below, communication of the first/second virtual reality headset 121a, 121b with the control processing system 170 utilises a protocol of the IEEE 802.11 standard (e.g., Wi-Fi).

The memory 126a, 126b of the first/second virtual reality headset 121a, 121b includes executable instructions which when executed by the processor 124a, 124b of the first/second virtual reality headset 121a, 121b, configure the processor 124a, 124b of the first/second virtual reality headset 121a 121b to perform the method 200 as discussed in relation to FIG. 2. In a preferable form, the executable instructions execute an instance of an executable virtual reality application 127 to generate, control and update the virtual reality environment. The virtual reality environment includes the virtual surroundings as well as one or more virtual characters/representations including those representing the one or more users 160a, 160b of the system 100. In one form, each instance of the executable virtual reality application 127 can be based on the Unity game engine.

In a preferable form, the first/second virtual reality headset 121a, 121b includes an accelerometer 132a, 132b and a gyroscope 138a, 138b. Thus, movement of the first/second user's head wearing the respective headset 121a, 121b can be detected based on one or more sensor signals obtained from the accelerometer 132a, 132b and/or gyroscope 138a, 138b such that the processor 124a, 124b of the virtual reality headset 121a, 121b is configured to update the virtual reality environment based on one or more sensor signals received from the accelerometer 131a, 132b and gyroscope 138a, 138b of the first/second virtual reality headset 121a, 121b.

In one form, the processor 104a, 104b of the sensor system 101a, 101b or the processor 124a, 124b of the first/second virtual reality headset 121a, 121b is preferably configured to detect the simulated firing of the first/second weapon 150a, 150b based on one or more sensor signals received from the accelerometer 112a, 112b. In one form, the recoil force is sensed by the accelerometer 112a, 112b which is classified as a firing of the first/second weapon 150a, 150b. The classification of the one or more sensor signals received from the accelerometer 112a, 112b can be performed using a machine trained model. Executable instructions representing the machine trained model are stored in the memory 106a, 106b of the first/second sensor system 101a, 101b or memory 126a, 126b of the first/second virtual reality headset 121a, 121b, wherein the one or more signals received from the accelerometer 112a, 112b are provided as input to the machine trained model, and an output is generated indicative of whether the one or more sensor signals are classified as a firing of the first/second weapon 150a, 150b.

The first/second weapon 150a, 150b is capable of firing a projectile, however the first/second weapon 150a, 150b is retrofitted with a first/second apparatus 610 to prevent firing of the projectile, but the first/second apparatus 610 is configured to simulate a recoil force of the firing of the first/second weapon 150a, 150b in response to a trigger of the first/second weapon 150a, 150b being activated by the first/second user 160a, 160b. In one form, the accelerometer 112a, 112b of the first/second sensor system 101a, 101b senses the recoil forces as a detected firing of the first/second weapon 150a, 150b, wherein the processor 124a, 124b of the first/second virtual reality headset 121a, 121b is configured to update the virtual reality environment to display a firing of the first/second weapon 150a, 150b in the virtual reality environment.

In one form, the apparatus 610 of the second weapon is a gas-powered simulated recoil system. The activation of the trigger results in a controlled release of compressed gas to act on the gun's bolt or slide to simulate a recoil force which is sensed by the accelerometer as a simulated firing of the first/second weapon. In one form, the gas-powered simulated recoil system is available from Dvorak Instruments Inc., 9402 E. 55th St, Tulsa, OK 74145, United States of America.

In another form, the apparatus 610 includes a solenoid which is electrically activated to act against a bolt of the first/second weapon 150a, 150b in response to activation of the first/second weapon 150a, 150b to generate the recoil force. In one form, the apparatus may be provided in the form of a bolt carrier group trigger resetter as described in PCT Application No. PCT/US2021/049174 which is herein incorporated by reference in its entirety.

In another form, the apparatus 610 may be provided in the form of a bolt assembly 610 as illustrated in FIGS. 6 to 11 and previously described.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above-described invention.

In this specification, the terms ‘comprises’, ‘comprising’, ‘includes’, ‘including’, or similar terms are intended to mean a non-exclusive inclusion, such that a method, system, or apparatus that comprises a list of elements does not include those elements solely but may well include other elements not listed.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

It will be appreciated that the order which steps are performed for the method(s) described above can altered unless otherwise specified.

1. A virtual reality system, including:
a piece of equipment;
a sensor system attachable to at least one of the user or the piece of equipment, wherein the sensor system includes a positional sensor, a gyroscope, an accelerometer, and a wireless communication interface, wherein the sensor system is configured to obtain, from the positional sensor, the gyroscope and/or the accelerometer, one or more sensor signals and wirelessly transfer sensor data; and
a virtual reality headset worn by a user associated with the equipment, including a processor, a memory, a display, an accelerometer, a positional sensor, and a wireless communication interface in communication with the sensor system;
wherein the memory of the virtual reality headset includes executable instructions which, when executed by the processor of the virtual reality headset, configure the virtual reality headset to:
present a virtual reality environment via the display to the user;
receive, from the sensor system via the wireless communication interface of the virtual reality headset, the sensor data; and
update, via the display and based on the sensor data, presentation of the virtual reality environment to display to the user.

2. The virtual reality system of claim 1, wherein the piece of equipment is a weapon.

3. The virtual reality system of claim 2, wherein the sensor system includes a sensor microcontroller including a processor and a memory having stored therein executable instructions which when executed by the processor of the sensor microcontroller, configure the processor of the sensor microcontroller to detect a simulated firing of the weapon based on one or more sensor signals received from the accelerometer.

4. The virtual reality system of claim 3, wherein the memory of the sensor microcontroller has stored therein executable instructions defining a machine-trained model for detecting the simulated firing of the weapon based on the one or more sensor signals received from the accelerometer.

5. The virtual reality system of any one of claims 2 to 4, further including a control processing device including a memory, a communication interface and a processor configured to establish a wireless network which allows the virtual reality headset to communicate wirelessly with the control processing system.

6. The virtual reality system of claim 5, wherein the wireless network utilises IEEE 802.11 family of wireless network protocols.

7. The virtual reality system of any one of claims 2 to 6, wherein the communication interface of the sensor system communicates with the virtual reality headset using a different wireless network.

8. The virtual reality system of claim 7, wherein the communication interface of the sensor system communicates with the virtual reality headset utilising IEEE 802.15.1 protocol.

9. The virtual reality system of any one of claims 5 to 8, wherein the control processing system is a tablet computing device.

10. The virtual reality system of any one of claims 5 to 9, wherein the control processing system has stored in the memory an executable software application which, when executed by the processor of the control processing system, configures the control processing system to present, via a display of the control processing system, a control interface to allow a trainer to select, via an input device of the tablet processing system, a training scenario for the user wearing the virtual reality headset.

11. The virtual reality system of any one of claims 5 to 10, wherein the control processing system is configured to receive, from the virtual reality headset, virtual reality data indicative of positional and orientation data associated with the virtual reality environment, regenerate the virtual reality environment based on the virtual reality data, and present a view of the regenerated virtual reality environment.

12. The virtual reality system of claim 11, wherein the virtual reality data, including the position and orientation data, is temporally dependent to allow the virtual reality environment to be regenerated according to time.

13. The virtual reality system of claim 12, wherein the control processing system is configured to store the virtual reality headset data in at least one of:
the memory of the control processing system; and
memory of a remote processing system.

14. The virtual reality system of any one of claims 11 to 13, wherein the control processing system is configured to present, via the display of the control processing system, the regenerated virtual reality environment.

15. The virtual reality system of any one of claims 2 to 14, wherein the virtual reality headset has stored in the memory executable instructions of an executable virtual reality application which, when executed by the processor of the virtual reality headset, generates and updates the virtual reality environment.

16. The virtual reality system of any one of claims 1 to 15, wherein the virtual reality headset receives, from the sensor system, calibration data indicative of a plurality of positional points in a real-world environment defining a plurality of points in the virtual reality environment, wherein the processor of the virtual reality headset generates the virtual reality environment based on the calibration data.

17. The virtual reality system of any one of claims 2 to 16, wherein the weapon is retrofitted with an apparatus configured to generate a recoil force in response to a trigger of the weapon being activated by the user to simulate the firing of a projectile.

18. The virtual reality system of claim 17, wherein the accelerometer of the sensor system is configured to sense the recoil force, wherein the processor of the virtual reality headset is configured to update the virtual reality environment to display a firing of the weapon in the virtual reality environment.

19. The virtual reality system of claim 18, wherein the apparatus includes a pressurised gas source which acts against a bolt of the weapon in response to activation of the weapon to generate the recoil force.

20. The virtual reality system of claim 18, wherein the apparatus includes a solenoid which is electrically activated to act against a bolt of the weapon in response to activation of the weapon to generate the recoil force.

21. The virtual reality system of any one of claims 2 to 20, wherein the sensor system of the weapon includes a capacitive sensor to sense the user gripping the weapon, wherein the sensor data transferred to the virtual reality headset is indicative of the user gripping the weapon, wherein the virtual reality headset is configured to update the display of the virtual reality headset to present the weapon being gripped in response to the sensor data being indicative of the user gripping the weapon.

22. The virtual reality system of any one of claims 2 to 21, wherein the sensor system includes a safety catch switch, wherein the one or more sensor signals includes a safety catch switch signal indicative of a user moving a safety catch of the weapon to a released position.

23. The virtual reality system of any one of claims 2 to 22, wherein the sensor system includes a trigger switch, wherein the one or more sensor signals includes a trigger switch signal indicative of a user pulling a trigger of the weapon.

24. The virtual reality system of any one of claims 2 to 23, wherein at least some of the sensor system is releasably mounted via a mounting device to the weapon via a rail system of the weapon.

25. The virtual reality system of claim 24, wherein the mounting device includes a clamping mechanism to releasably secure at least some of the sensor system to the rail system of the weapon.

26. The virtual reality system of any one of claims 2 to 25, wherein the sensor system is a distributed system including a first sensor subsystem and a second sensor subsystem, wherein the first sensor subsystem is coupled to the weapon and the second sensor subsystem is coupled to the user.

27. The virtual reality system of claim 26, wherein the second sensor subsystem is coupled to the user's wrist.

28. The virtual reality system of claim 26 or 27, wherein the first sensor subsystem includes the gyroscope, the accelerometer, and the communication interface, and the second sensor subsystem includes the positional sensor, a further gyroscope, a further accelerometer, and a further communication interface, wherein the communication interface and the further communication interface wirelessly transfer a first portion and second portion of sensor data to the virtual reality headset respectively.

29. The virtual reality system of any one of claims 2 to 4, further comprising:
a second weapon;
a second sensor system, coupled to the second weapon, including: a positional sensor; a gyroscope; an accelerometer; and a wireless communication interface, wherein the second sensor system is configured to receive, from the positional sensor, the gyroscope and/or the accelerometer, one or more sensor signals and wirelessly transfer sensor data; and
a second virtual reality headset worn by a second user associated with the second weapon, including a processor, a memory, a display, an accelerometer, a positional sensor, and a wireless communication interface in communication with the second sensor system;
wherein the memory of the second virtual reality headset includes executable instructions which, when executed by the processor of the second virtual reality headset, configure the second virtual reality headset to:
present the virtual reality environment via the display to the second user;
receive, from the second sensor system via the wireless communication interface of the second virtual reality headset, second sensor data; and
update, via the display and based on the second sensor data, presentation of the virtual reality environment to the second user.

30. The virtual reality system of claim 29, further including a control processing device configured to establish a wireless network which allows the virtual reality headset and second virtual reality headset to communicate wirelessly with the control processing system.

31. The virtual reality system of claim 30, wherein the wireless network utilises a wireless network protocol from IEEE 802.11 family of wireless network protocols.

32. The virtual reality system of any one of claims 29 to 31, wherein the communication interface of the sensor system and the second sensor system is configured to communicate with the virtual reality headset using a different wireless network compared to communication with the control processing system.

33. The virtual reality system of claim 32, wherein the communication interface of the sensor system and the second sensor system communicate with the virtual reality headset utilising IEEE 802.15.1 protocol.

34. The virtual reality system of any one of claims 30 to 33, wherein the control processing system is a tablet computing device.

35. The virtual reality system of any one of claims 30 to 34, wherein the control processing system has stored in memory an executable virtual reality application which when executed by the tablet processing system configures a display of the tablet processing system to present a control interface to allow a trainer to select, via an input device of the tablet processing system, a training scenario for the user wearing the virtual reality headset and the second user wearing the second virtual reality headset.

36. The virtual reality system of any one of claims 30 to 35, wherein the control processing system is configured to relay virtual reality data between the virtual reality headset and the second virtual reality headset, wherein:
the virtual reality headset is configured to update presentation of the virtual reality environment presented to the user based on the virtual reality data received from the second virtual reality headset; and/or
the second virtual reality headset is configured to update presentation of the virtual reality environment presented to the second user based on the virtual reality data received from the virtual reality headset.

37. The virtual reality system of any one of claims 5 to 10, wherein the virtual reality data is indicative of positional and orientation data associated with the virtual reality environment, wherein the control processing system is configured to regenerate the virtual reality environment based on the virtual reality data and present a view of the regenerated virtual reality environment.

38. The virtual reality system of claim 37, wherein the virtual reality data is temporally dependent to allow the virtual reality environment to be regenerated according to time.

39. The virtual reality system of claim 37 or 38, wherein the control processing system is configured to store the virtual reality data in at least one of:
the memory of the control processing system; and
memory of a remote processing system.

40. The virtual reality system of any one of claims 36 to 39, wherein the control processing system is configured to determine, based on the received virtual reality data, whether a firing path of the weapon of the user intersects with a virtual reality representation of the second user in the virtual reality environment and/or whether a firing path of path of the second weapon of the second user intersects with a virtual reality representation of the user in the virtual reality environment.

41. The virtual reality system of any one of claims 30 to 40, wherein the virtual reality headset has stored in the memory executable instructions to execute a first instance of an executable virtual reality application to generate and update the virtual reality environment for the virtual reality headset, and wherein the second virtual reality headset has stored in the memory executable instructions to execute a second instance of the executable virtual reality application to generate and update the virtual reality environment for the second virtual reality headset.

42. The virtual reality system of any one of claims 29 to 41, wherein the virtual reality headset is configured to receive, from the sensor system, calibration data indicative of a plurality of positional points in a real-world environment defining a plurality of points in the virtual reality environment, wherein the processor of the virtual reality headset is configured to generate the virtual reality environment based on the calibration data, wherein the second virtual reality headset is configured to receive, from the second sensor system, second calibration data indicative of a plurality of positional points in the real-world environment defining a plurality of points in the virtual reality environment, wherein the processor of the second virtual reality headset is configured to generate the virtual reality environment based on the second calibration data.

43. The virtual reality system of any one of claims 30 to 42, wherein the weapon is retrofitted with an apparatus configured to generate a recoil force in response to a trigger of the weapon being activated by the user to simulate firing of the weapon, and wherein the second weapon is retrofitted with a second apparatus configured to generate a recoil force in response a trigger of the second weapon being activated by the second user and simulate firing of the second weapon.

44. The virtual reality system of claim 43, wherein the accelerometer of the sensor system is configured to sense the recoil force generated by the apparatus, wherein the processor of the virtual reality headset is configured to update the virtual reality environment to display a firing of the weapon in the virtual reality environment, wherein the accelerometer of the second sensor system is configured to sense the recoil force generated by the second apparatus, wherein the processor of the second virtual reality headset is configured to update the virtual reality environment to display a firing of the second weapon in the virtual reality environment.

45. The virtual reality system of claim 44, wherein the apparatus includes a pressurised gas source which acts against a bolt of the weapon in response to activation of the weapon to generate the recoil force, and wherein the second apparatus includes a second pressurised gas source which acts against a bolt of the second weapon in response to activation of the second weapon to generate the recoil force.

46. The virtual reality system of claim 44, wherein the apparatus includes a solenoid which is electrically activated to act against a bolt of the weapon in response to activation of the weapon to generate the recoil force, and wherein the second apparatus includes a solenoid which is electrically activated to act against a bolt of the second weapon in response to activation of the second weapon to generate the recoil force.

47. The virtual reality system of any one of claims 30 to 46, wherein the sensor system of the weapon includes a capacitive sensor to sense the user gripping the weapon, wherein the sensor data transferred to the virtual reality headset is indicative of the user gripping the weapon, wherein the virtual reality headset is configured to update the display of the virtual reality headset to present the weapon being gripped in response to the sensor data, wherein the second sensor system of the second weapon includes a second capacitive sensor to sense the second user gripping the second weapon, wherein the sensor data transferred to the second virtual reality headset is indicative of the second user gripping the second weapon, wherein the second virtual reality headset is configured to update the display of the second virtual reality headset to present the second weapon being gripped in response to the sensor data.

48. The virtual reality system of any one of claims 30 to 47, wherein the sensor system includes a safety catch switch, wherein the one or more sensor signals includes a safety catch switch signal indicative of the user moving a safety catch of the weapon to a released position, wherein the second sensor system includes a safety catch switch, wherein the one or more sensor signals obtained by the second sensor system includes a safety catch switch signal indicative of the second user moving a safety catch of the second weapon to a released position.

49. The virtual reality system of any one of claims 30 to 48, wherein the sensor system includes a trigger switch, wherein the one or more sensor signals obtained by the sensor system includes a trigger switch signal indicative of a user pulling a trigger of the weapon, wherein the second sensor system includes a trigger switch, wherein the one or more sensor signals obtained by the second sensor system includes a trigger switch signal indicative of a user pulling a trigger of the second weapon.

50. The virtual reality system of any one of claims 30 to 49, wherein at least some of the sensor system is releasably mounted via a mounting device to the weapon via a rail system of the weapon, wherein at least some of the second sensor system is releasably mounted via a second mounting device to the second weapon via a rail system of the second weapon.

51. The virtual reality system of claim 50, wherein the mounting device includes a clamping mechanism to releasably secure at least some of the sensor system to the rail system of the weapon, wherein the second mounting device includes a clamping mechanism to releasably secure at least some of the second sensor system to the rail system of the second weapon.

52. The virtual reality system of any one of claims 30 to 51, wherein the sensor system is a distributed system including a first sensor subsystem and a second sensor subsystem, wherein the first sensor subsystem is coupled to the weapon and the second sensor subsystem is coupled to the user, wherein the second sensor system is a distributed system including a further first sensor subsystem and a further second sensor subsystem, wherein the further first sensor subsystem is coupled to the second weapon and the further second sensor subsystem is coupled to the second user.

53. The virtual reality system of claim 52, wherein the second sensor subsystem is coupled to the user's wrist, and wherein the further second sensor subsystem is coupled to the second user's wrist.
